(19) United States
(12) Patent Application Publication
(10) Pub. No.: US 2006/0196619 A1
(43) Pub. Date: Sep. 7, 2006

(54) Venetian blind slat structure

(75) Inventor: Wen Ying Liang, Chanhua County (TW)

Correspondence Address: TROXELL LAW OFFICE PLLC, 5205 LEESBURG PIKE, SUITE 1404, FALLS CHURCH, VA, 22041, US

(73) Assignee: Ching Feng Home Fashions Co., Ltd.

(21) Appl. No.: 11/099,647

(22) Filed: Apr. 6, 2005

(30) Foreign Application Priority Data
Mar. 1, 2005 (TW) 094203117

(51) Int. Cl. E06B 3/12

(52) U.S. Cl. 160/236

(57) ABSTRACT

A Venetian blind slat structure includes a slat body made of plastic materials, compound materials, glass fibers, and textile materials, etc., that is directly wound inwards from both elongate outer edges thereof to wrap around a support member made of plastic materials, wood, compound materials, and glass fibers, etc. at each rolled-up elongate edge therein and securely bound therewith via a coupling portion. Therefore, via the aforementioned structure, the blind slat obtained thereby is economically manufactured in an easy and speedy manner. Besides, via the coupling portions thereof, the slat body can not only achieve versatile stylistic change to boost the visual effect thereof, but also refrain from the problem of furry edges in production to achieve a neat and beautiful look in display thereof.

### BACKGROUND OF THE INVENTION

The present invention is related to a Venetian blind slat structure, including a slat body that is directly wound inwards from both elongate outer edges thereof to wrap around a support member at each rolled-up elongate edge therein and securely bound therewith via a coupling portion; whereby, the blind slat obtained thereby can not only achieve versatile stylistic change to boost the visual effect thereof, but also refrain from the problem of furry edges in production to achieve a neat and beautiful look in display thereof.

Please refer to FIG. 1. A conventional blind slat structure comprises a slat body 10 made of textile materials that is integrally woven into shape with a retaining space 11 formed at each elongate edge thereon for holding a support member 12 therein.

However, the conventional blind slat structure above contains some disadvantages. First, the slat body 10 is integrally made without any connecting portions disposed thereon for further decoration purpose and is prone to become defected with uneasily trimmed furry edges A formed in the production thereof which can easily destroy the look of the blind slat in display. Second, the support members 12 thereof must be accommodated into the retaining spaces 11 of the slat body 10 therein respectively, which is uneconomically troublesome in assembly and inflexibly dull in appearance thereof.

### SUMMARY OF THE PRESENT INVENTION

It is, therefore, the primary purpose of the present invention to provide a Venetian blind slat structure, including a slat body that is directly wound inwards from both elongate outer edges thereof to wrap around a support member at each rolled-up elongate edge therein and securely bound therewith via a coupling portion, facilitating an easier and speedier manufacturing of the blind slat thereof to achieve the economical efficiency thereby.

It is, therefore, the second purpose of the present invention to provide a Venetian blind slat structure wherein, via the coupling portions thereof, the blind slat obtained thereby can not only provide versatile stylistic change to boost the visual effect thereof, but also refrain from the problem of furry edges in production to achieve a neat and beautiful look in display thereof.

### BRIEF DESCRIPTION OF THE DRAWINGS

FIG. 1 is a perspective view of a conventional blind slat structure.

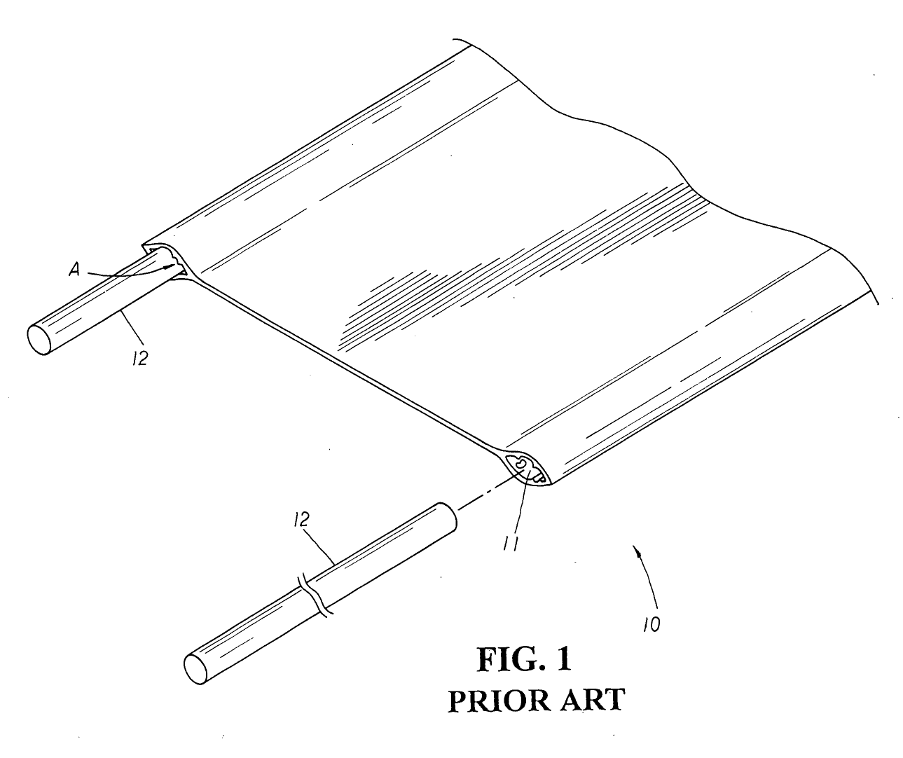

FIG. 2 is a perspective view of the present invention in assembling process thereof.

FIG. 3 is a perspective view of the present invention in assembly.

FIG. 4 is a perspective view of another embodiment of the present invention in assembly.

### DETAILED DESCRIPTION OF THE PREFERRED EMBODIMENTS

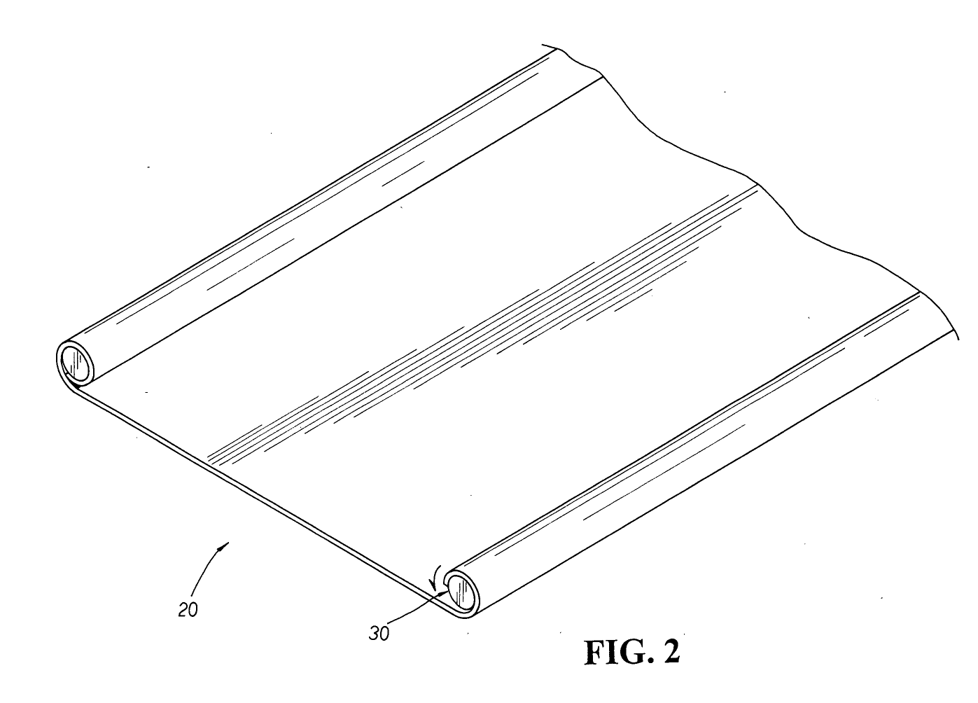

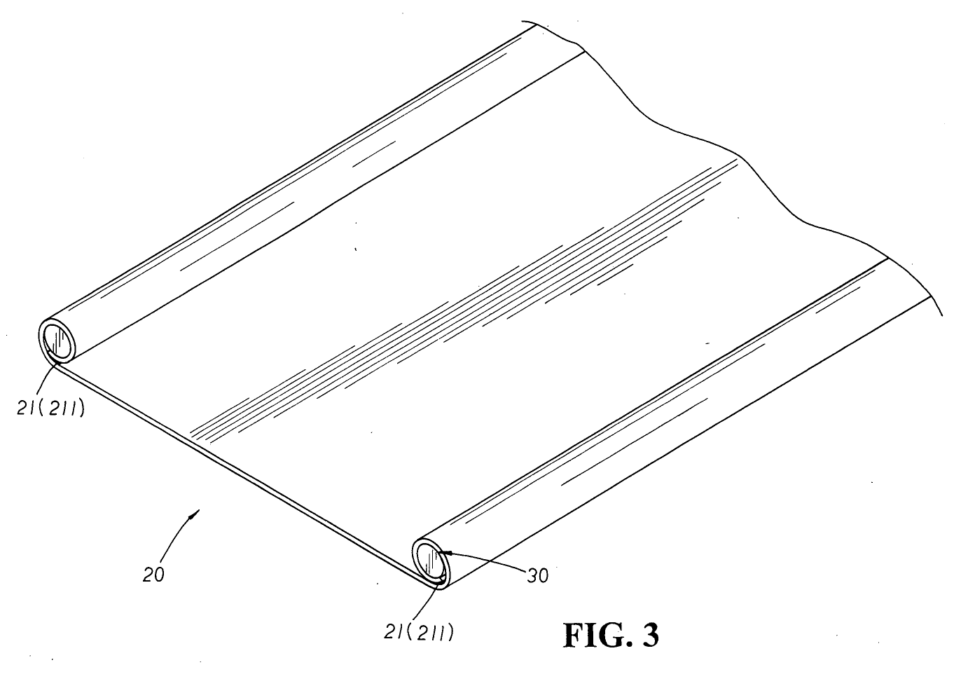

Please refer to FIGS. 2 through 3 inclusive. The present invention is related to a Venetian blind slat structure, including a slat body 20 made of plastic materials, compound materials, glass fibers, and textile materials, etc., that is symmetrically wound inwards from both elongate outer edges of one side surface thereof to directly wrap around a support member 30 made of plastic materials, wood, compound materials, and glass fibers, etc at each rolled-up elongate edge therein and securely bound therewith via a coupling portion 21 like adhesive agent 211 as shown in FIG. 3. Therefore, the blind slat obtained thereby is economically manufactured in an easy and speedy manner. Besides, via the coupling portions 21 thereof, the slat body 20 can not only achieve versatile stylistic change to boost the visual effect thereof, but also refrain from the problem of furry edges in production to achieve a neat and beautiful look of the blind slat in display thereof.

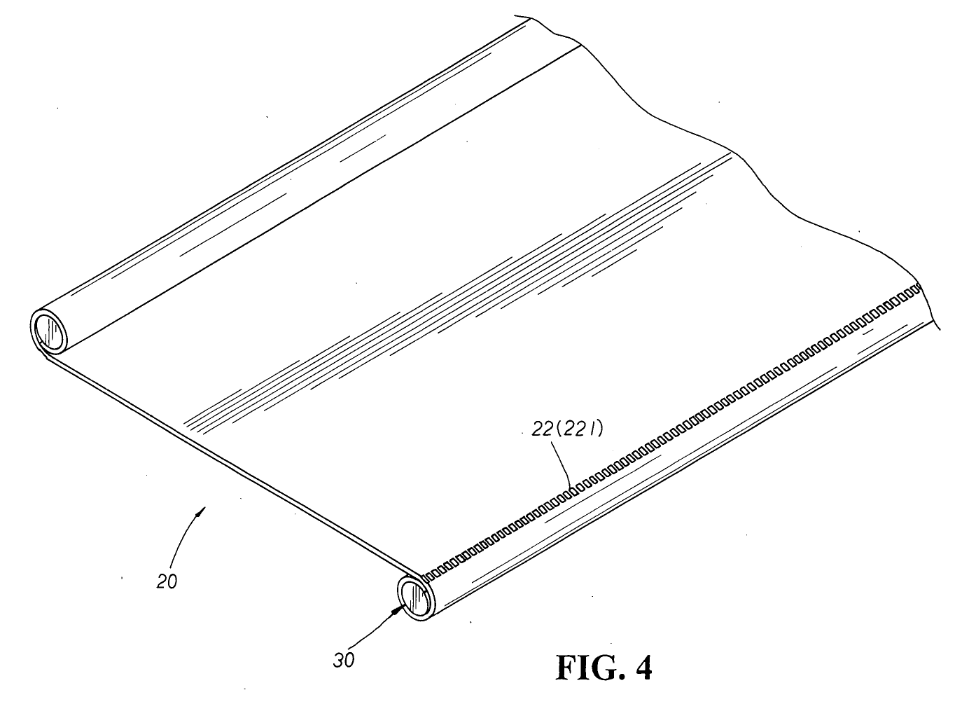

Please refer to FIG. 4 showing another embodiment of the present invention. The slat body 20 of the present invention can also have both elongate outer edges thereof alternatively wound inwards in opposite directions from both upper and lower side surfaces thereof respectively to wrap around a support member 30 therein and securely engaged therewith via a coupling portion 22 like ultrasonic thermo welding line 221 as shown in FIG. 4.

Moreover, the coupling portions 21, 22 of the slat body 20 can be mad of adhesive agent 211 and ultrasonic thermo welding lines 221 thereof.

What is claimed is:

1. A Venetian blind slat structure, including a slat body that is directly wound inwards from both elongate outer edges thereof to wrap around a support member at each rolled-up elongate edge therein and securely bound therewith via a coupling portion, facilitating an easier and speedier manufacturing of the blind slat thereof wherein, via the coupling portions thereof, the slat body can not only achieve versatile stylistic change to boost the visual effect thereof, but also refrain from the problem of furry edges in production to achieve a neat and beautiful look in display thereof.

2. The Venetian blind slat structure as claimed in claim 1 wherein the slat body thereof can be made of plastic materials, compound materials, glass fibers, and textile materials, etc.

3. The Venetian blind slat structure as claimed in claim 1 wherein coupling portions of the slat body thereof can be made of adhesive agent, and ultrasonic thermo welding lines, etc.

4. The Venetian blind slat structure as claimed in claim 1 wherein the support members can be symmetrically arranged and wrapped around by the rolled-up elongate edges at one side surface of the slat body thereon.

5. The Venetian blind slat structure as claimed in claim 1 wherein the support members can also be alternatively arranged and wrapped around by opposite elongate edges at the upper and lower side surfaces of the slat body thereon respectively.
